(19) United States
(12) Patent Application Publication
(10) Pub. No.: US 2025/0191615 A1
(43) Pub. Date: Jun. 12, 2025

(54) METHODS, SYSTEMS, AND COMPUTER PROGRAM PRODUCTS FOR GENERATING A UNIVERSAL TIME OVERLAY FOR VIDEO FILES USING MODIFIED METADATA

(71) Applicant: Fusus, LLC, Scottsdale, AZ (US)

(72) Inventors: Christopher R. Lindenau, Peachtree Corners, GA (US); David A. Robinson, Atlanta, GA (US); Sergio Fernandez, Delray Beach, FL (US); Vladimir Safin, Delray Beach, FL (US); Eugenio E. Breijo, Dunwoody, GA (US)

(21) Appl. No.: 18/979,374

(22) Filed: Dec. 12, 2024

Related U.S. Application Data
(60) Provisional application No. 63/609,070, filed on Dec. 12, 2023.

(51) Int. Cl. G11B 27/10; G06F 21/60; G11B 27/036

(52) U.S. Cl. CPC G11B 27/10; G06F 21/602; G11B 27/036

(57) ABSTRACT

The subject matter disclosed herein includes methods and systems for generating and for displaying a video file including verified time information using appended video metadata. The video file is created at a video source or a device associated with a video source configured for recording or streaming a raw video file. The video source or a device associated with the video source communicates with a remote time source to determine verified time information for every portion of the video and generates a time-stamped video file by appending metadata associated with the raw video file with the verified time information.

### FIELD OF THE DESCRIPTION

The present description relates, in general, to video files and, more particularly, to a system configured to generate and display a time-stamped video file having raw video information and a time metadata.

### BACKGROUND

Recent years have seen increasing use of security cameras by businesses and homeowners, cell phones by the public, and other video sources. As a result, there has been an increase in the use of video as evidence in trials and other court proceedings. By some estimates, as much as 80 percent of crimes involve video evidence. The use of video evidence is subject to State and/or Federal Rules of Evidence. One requirement of these evidentiary rules is that the video evidence must be lawfully obtained, from a reliable source, authentic, and not manipulated, tampered with, or falsified in any way. Thus, how a video is recorded, edited, transmitted, and stored are important considerations if the video is to be successfully introduced as evidence in court.

### BRIEF DESCRIPTION OF THE DRAWINGS

FIGS. 1A and 1B are a functional block diagram of a system configured according to the present description.

FIG. 2 is a flow diagram of a method of the present description that may be implemented during operation of the system.

FIG. 3 is a diagram on exemplary video metadata according to an embodiment of the subject matter described herein.

FIG. 4 is an illustration of an exemplary user interface of a video player according to an embodiment of the subject matter described herein.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Additionally, any reference to without contact (or similar phrases) may also include reduced contact or minimal contact.

Systems, methods, and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

In various embodiments, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

In various embodiments, computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts described below. Similarly, the computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Further, the computer program instructions may also be loaded onto a computer, other programmable data processing apparatus, or other devices to cause a series of operational steps to be performed to provide processes for implementing the functions/acts described below.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

In various embodiments, a cloud-based system may be configured to associate accurate and/or verified time information with a video file such. Additionally, the verified time information may be appended to the video file such that the video file remains admissible in court based on the rules of evidence. Further, the video file and the verified time information may be stored as digital video evidence in a secure digital vault (which may be configured to be compliant with various jurisdictional laws and regulations) that can then be made accessible to investigators.

In various embodiments, the system may be configured as “cloud-based system” in that it provides a central hub or repository for gathering live video streams and appending time information to provide a time-stamped video file. A user may access the time-stamped video file via a video player executed on desktop or other computing device. In other embodiments, a client device associated with the video source may process video streams and time information to generate a time-stamped video file and provide the time-stamped video file to the central hub or repository. Generally, a system may be configured to generate a time-stamped video file having raw video information and a time metadata.

The subject matter disclosed herein includes methods and systems for generating and for displaying a video file including accurate time information using modified video metadata. According to one embodiment, the video file including accurate time information is created at a video source or a device associated with a video source configured for recording or streaming a raw video file. The video source or a device associated with the video source communicates with a remote time source to determine time information for every portion of the video and generates a time-stamped video file by modifying metadata associated with the raw video file to include the time information.

Correspondingly, displaying the time-stamped video file includes displaying the raw video information as a first presentation layer and displaying the timestamp information as a second presentation layer. The second presentation layer is independent from the first presentation layer. The second presentation layer is overlaid on top of the first presentation layer such that at least a portion of the first presentation layer is obscured by at least a portion of the second presentation layer.

In certain applications, a video may not be modified to include a timestamp after it is received from a video source. This restriction creates various problems. A first problem is that the displayed timestamp may be inaccurate because it is not externally verified by, for example, coordinating with an authoritative clock or time server. Moreover, many video sources require manual adjustment of the local time for daylight savings, time zone, etc. which may not have been performed. A second problem is that the displayed timestamp is integrated with the video itself rather than being a separable overlaid display layer. This causes at least some of the pixels in the video to be replaced with the added timestamp information.

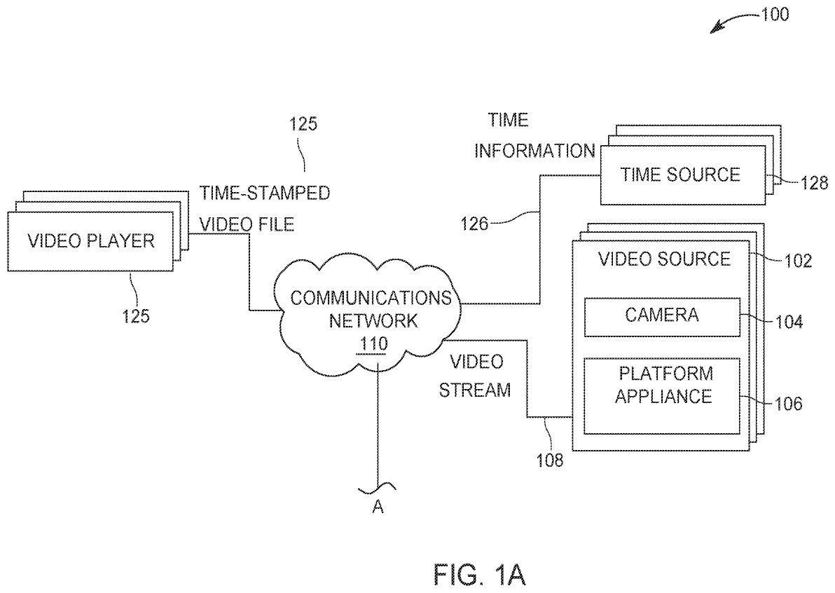

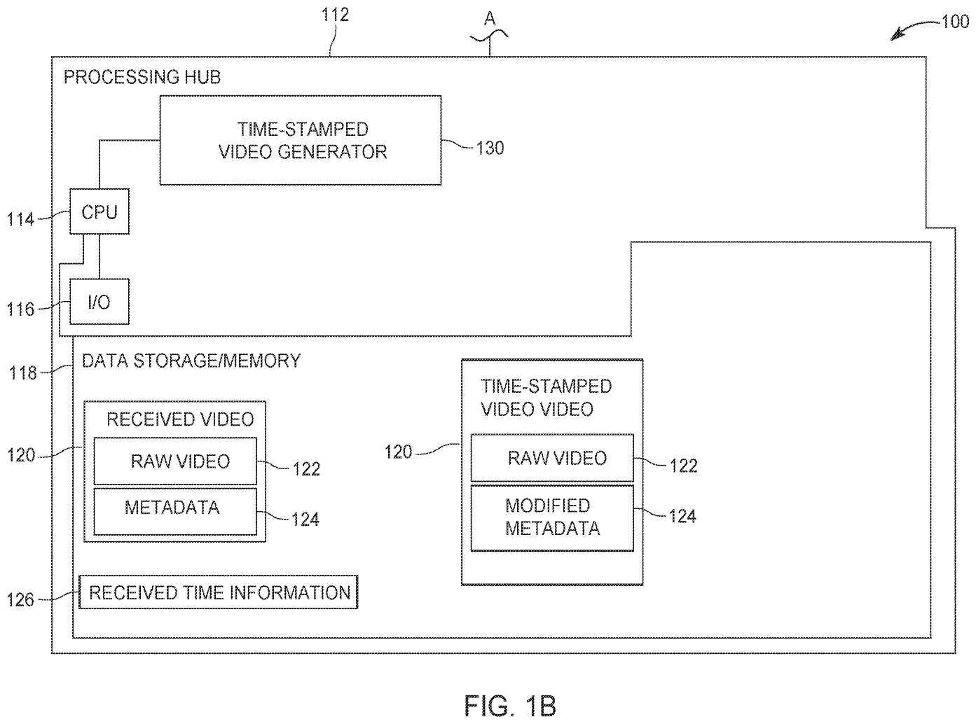

FIGS. 1A and 1B depict a functional block diagram of system 100 of the present description. The system 100 includes a processing hub 112 shown to be linked (e.g., for digital communications), via digital communications network 110, to video sources 102 and time sources 128. The processing hub 112 is cloud-based (e.g., a Software as a Service (SaaS) platform or the like) so that it is accessible from any Internet-connected computer device or cell or smartphone.

The system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer, and the like.

In various embodiments, dispatch system 100 may be implemented as one or more computing devices that connect to, communicate with, interact with, and/or exchange data over a link. Individual computing devices may comprise a processing unit-based device with sufficient processing power, memory/storage, and connectivity/communications capabilities to connect to and interact with the system. For example, each computing device may be an a mobile device (e.g., a mobile phone, a smart phone, etc.), a personal computer, a tablet computer, a laptop computer, and/or other computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In various embodiments, a computing device may comprise a display and a browser application so that the display can provide information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

In various embodiments, the system may comprise a server (that may be software based or hardware based) that enables one or more computing devices to connect to and interact with the system. For example, the server may enable sending information and receiving information from the one or more computing devices. The system may further comprise software- and/or hardware-based modules and database(s) for processing and storing content associated with the system, metadata generated by the system for each piece of content, user preferences, and the like.

In various embodiments, the system may include one or more processors, servers, clients, data storage devices, and non-transitory computer readable instructions that, when executed by a processor, cause a device to perform one or more functions. It is appreciated that the functions described herein may be performed by a single device or may be distributed across multiple devices.

In various embodiments, a user may interact with the system via a client application. The client application may include a user interface (e.g., a graphical user interface) that allows the user to select one or more digital files. The client application may communicate with a backend component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

In various embodiments, system 100 may include one or more devices that communicate directly or indirectly with the hub 112 over the network 110. The hub 112 may comprise one-to-many computing and data storage devices that are cloud-based or accessible via communications network 110. For ease of explanation, hub 112 is depicted to include a processor 114 that manages input/output (I/O) devices 116. One or more I/O devices 116 may facilitate receipt and transmittal of communications over the network 110 to and/or from the system 100, the time sources 128, and the video sources 102. The processor 114 may manage storage and retrieval of information to data storage/memory 118, which may be any data storage device such as a server accessible directly or over the network 110 by processor 114. Hub 112 may provide access to functionality of time-stamped video generator 180 (which is described below). Generally, processing hub 112 may receive one or more video streams 108 from one or more video sources 102 and (such as via operations of the time-stamped video generator 180) process the one or more video streams 108 for storage in memory 118. The video stream 108 may include raw video information and associated metadata.

In various embodiments, one or more video sources 102 may be configured as a variety of devices. For example, the one or more video sources 102 may be configured in the form of one or more drones, traffic cameras, private cell phone video, building security cameras, user-utilized robots with cameras, and so on. Each source may provide a video stream 108 that may be stored in memory 118 as received video 120. The received video 120 may include a raw video component 122 and a metadata component 124.

In various embodiments, platform appliance 106 may be provided at one or more of the video source(s) 102 to facilitate communication of the one or more video stream 108 to the hub 112. For example, platform appliance 106 may be a hardware device that is small, lightweight, and configured to be a plug-and-play device that connects to the camera 104 (or to a network to which the source 102 is linked and/or accessible). Alternatively, platform appliance 106 may be a centralized device that resides on a network with the one or more video sources 102. Generally, platform appliance 106 may be associated with one or more video sources 102 to integrate the one or more video sources 102 with system 100 (e.g., video source 102 is connected with a cloud network associated with hub 112 via platform appliance 106).

In various embodiments, one or more platform appliances 106 may be connected to one or more video sources 102 (such as individual cameras or networks of such cameras). A platform appliance 106 may be configured to enable a secure live video feed 108 to hub 112. Platform appliance 106 may connect with a video source 102 (e.g., a camera 104) to enable network capability and analytic capability for the video source 106.

In various embodiments of system 100, video information and time information may be analyzed and/or processed at camera 104 (e.g., video source 102) or at platform appliance 106. Additionally, video information may be transferred to hub 112 via communications network 110. Further, hub 112 may obtain and/or receive time information 126 from one or more time sources 128. Hub 112 may process and store time information 126 in memory 188. Time information 126 may include a plurality of timestamps generated based at least on a predetermined interval (e.g., 2 ms, 5 ms, 10 ms, 100 ms, 1 sec, 1 min, 1 hr, etc.). Time information 126 may include date information. Time information 126 may include time zone and daylight savings indications. Time information 126 may be verified against one or more time standards to ensure accuracy and precision during generation of the plurality of timestamps. Data 118 may be used to display, hide, or move various elements as needed in user-selectable or default data/video layers.

In various embodiment, hub 130 may comprise a time-stamped video generator 180. Time stamped video generator 180 may be configured to create a time-stamped video file that includes at least raw video and metadata that includes one or more timestamps associated with the raw video. In particular, raw video may be video generated by a video source 102 that is not modified, altered, edited, and/or otherwise tampered with. Alternatively stated, the raw video may be original video information that has been generated by the video source 102. During operation of the system, raw video may be received (e.g., via an encrypted video stream) at hub 112 such that the raw video contains the unmodified, original video information generated by video source 102. System 100 may then respond by determining, based at least on a remote time source (e.g., such as a Network Time Protocol (NTP) server), a universal time and a local time for individual frames in the raw video. System 100 may determine time information (e.g., universal time information, local time information, etc.) for every frame in the raw video. System 100 may determine time information for one or more keyframes in the raw video. As a result, raw video information may be appended with time information to generate time-stamped video file 120. Further, system 100 may generate the time-stamped video file 120 to comprise the raw video and the time information in separate layers. For example, time-stamped video file 120 may provide the raw video in a first layer and the time information in a second layer, via an interface generator, to video players 125.

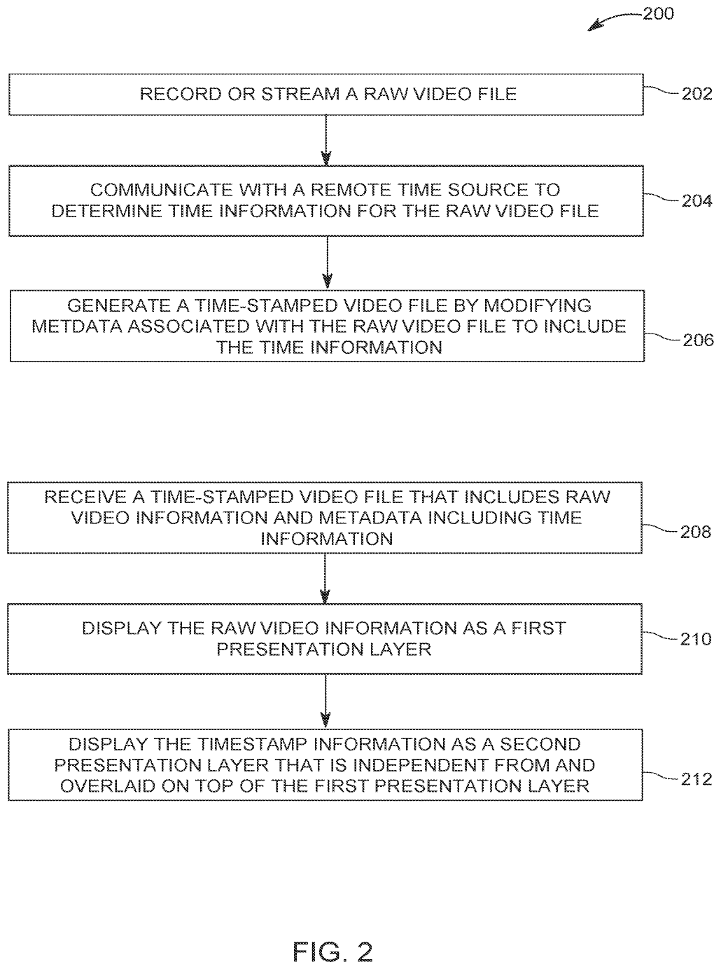

FIG. 2 is a flow diagram of a method of the present description that may be implemented during operation of the system. Some steps may be directed to assembling, generating, or otherwise generating a time-stamped video file that includes both a raw video portion that is unmodified and a metadata portion that has been modified to include timestamps for frames of the raw video by synchronizing with an authoritative time source. Corresponding steps may be directed to receiving, storing, and displaying a time-stamped video file generated by the video source or appliance device coupled with the video source.

In various embodiments, and at step 202, a system may receive a raw video file associated with a video source. The raw video filed may be recorded by and/or streamed from a video source (e.g., video source 102, camera 104, etc.) to the system (e.g., system 100) via a communication network (e.g., communication network 110) and/or other data connection. Generally, the raw video file and/or one or more additional video files received by the system may contain unmodified video information.

In various embodiments, and at step 204, a system may communicate with a remote time source (e.g., a verified time source, a standardized time source, a trusted time source, etc.) to determine time information for the raw video file. For example, the remote time source may be a public network time protocol (NTP) server. It should be noted that determination of a “true” time is virtually impossible and is the domain of high-precision timekeeping devices such as atomic clocks. As such, the time information includes an estimate of the “true” time that is accurate to within a predetermined interval, such as 10 ms. As a result, the time information received from the remote time source may be determined to an error interval less than the predetermined interval. For example, where the predetermined interval is 10 ms, the time information may be verified by the remote time source as being within an error interval of 10 ms from the “true” time. The time information may be determined based at least on a local time when the video file was recorded and/or streamed relative to Coordinated Universal Time. The time information may be determined based at least on a global time when the video file was recorded and/or streamed.

In various embodiments, the system, as disclosed herein, may communicate with an independent, authoritative, and/or remotely located time server implementing the network time protocol (NTP). Generally, NTP is a networking protocol for clock synchronization between computer systems over a communication network (e.g., packet-switched, variable-latency data networks). NTP may be utilized to synchronize one or more participating computers and/or systems to within a predetermined interval from Coordinated Universal Time (UTC). Additionally, NTP may use an intersection algorithm to select accurate time servers. NTP may be designed to mitigate effects of variable network latency. The intersection algorithm may be a method for estimating accurate time from a set of time sources, wherein individual time sources of the set of time sources are associated with an error and/or a variability. The intersection algorithm may utilize, as an estimate of the true time, the smallest interval consistent with the largest number of sources. For example, NTP and the intersection algorithm may maintain time information for the system to the predetermined interval (e.g., within tens of milliseconds) over a communication network. For example, NTP and the intersection algorithm may maintain time information for the system to sub-millisecond accuracy in local area networks. NTP may be utilized by the system to send and receive one or more timestamps using various communication protocols. NTP may utilize broadcasting or multicasting, wherein one or more clients may passively listen to one or more time updates after an initial round-trip calibrating exchange. Generally, NTP may use a client-server model, a peer-to-peer relationship model (e.g., where both peers consider the other to be a potential time source), and other communication models to distribute time information for the system. It should be noted that one or more additional time protocols and/or servers may be used without departing from the scope of the subject matter described herein.

In various embodiments, NTP may use a hierarchical, semi-layered system of time sources. Each level of this hierarchy is termed a “stratum” and is assigned a number starting with zero for the reference clock at the top. A server synchronized to a stratum n server runs at stratum n+1. The number represents the distance from the reference clock and is used to prevent cyclical dependencies in the hierarchy. Stratum is not always an indication of quality or reliability. Stratum 0 time sources are high-precision timekeeping devices such as atomic clocks, GNSS (including GPS) or other radio clocks, or a PTP-synchonized clock. They generate a very accurate pulse per second signal that triggers an interrupt and timestamp on a connected computer. Stratum 0 devices are also known as reference clocks. Stratum 1 time sources are computers whose system time is synchronized to within a few microseconds of their attached stratum 0 devices. Stratum 1 servers may peer with other stratum 1 servers for sanity check and backup. They are also referred to as primary time servers. Stratum 2 time sources are computers that are synchronized over a network to stratum 1 servers. Often a stratum 2 computer queries several stratum 1 servers. Stratum 2 computers may also peer with other stratum 2 computers to provide more stable and robust time for all devices in the peer group. Stratum 3 time sources are computers that are synchronized to stratum 2 servers. They employ the same algorithms for peering and data sampling as stratum 2 and can themselves act as servers for stratum 4 computers, and so on. The upper limit for stratum is 15. Stratum 16 is used to indicate that a device is unsynchronized.

In various embodiments, and at step 206, the system may generate a time-stamped video file. The system may preserve the raw video by modifying metadata associated with the raw video file to include the time information. For example, the system may modify the video metadata by adding one or more fields. The time information may include a timestamp associated with each frame of the video. Alternatively, or in addition, the time information may include one or more timestamps calculated by interpolating between one or more reference frames (e.g., keyframes). The system may append one or more timestamps associated with the time information into the video metadata.

In various embodiments, a video source (e.g., video source 102, camera 104, etc.), or appliance device (e.g., platform appliance 106) connected to the video source, may save the time-stamped video file locally, upload the time-stamped video file to a remote storage (e.g., a cloud platform), and/or stream the time-stamped video file to another device.

In various embodiments, the time-stamped video file and the associated metadata may be encrypted upon recording or creation. The time-stamped video file may be encrypted prior to and/or during transmission from the video source to a remote storage location and/or a remote device. The time-stamped video file may be encrypted when stored in the cloud. Encryption of the time-stamped video file may prevent modifying, altering, editing, and/or otherwise tampering with the raw video and/or the video metadata that includes the time information. The time-stamped video file may be decrypted in real-time as it is played.

In various embodiments, and at step 208, the system may receive a time-stamped video file that includes raw video information and metadata including time information. As discussed above, the metadata portion of the time-stamped video file may be modified to include additional fields (properties: values) that indicate when a particular frame of the raw video file was recorded via an associated timestamp. The timestamp may be expressed in a format relative to UTC.

In various embodiments, and at step 210, the system may display the time-stamped video file. Displaying the time-stamped video file may include displaying the raw video information as a first presentation layer. For example, the raw video information may be displayed in an unmodified form via a software player that is configured to support the encoding format and other aspects of the raw video file.

In various embodiments, and at step 212, the system may display the timestamp information as a second presentation layer. The second presentation layer may be independent from the first presentation layer. The second presentation layer may be overlaid onto the first presentation layer such that at least a portion of the first presentation layer is obscured by at least a portion of the second presentation layer.

In various embodiments, the second presentation layer may be mobile relative to the first presentation layer and/or a display interface. For example, the user may click to drag the overlaid timestamp layer from a first corner of the display interface to a second corner different from the first corner. Additionally, movement of the second presentation layer may cause the obscured portion of the first presentation layer to be displayed and a visible portion of the first presentation layer to be obscured by the second presentation layer. For example, the one or more numbers and/or one or more letters of the overlaid timestamp layer may be opaque (e.g., enabling legibility) such that when displayed in a bottom right corner of a security tape, the overlaid timestamp layer obscures a suspect face. During this portion of the security tape, the user may drag the overlaid timestamp layer to the bottom left corner of the display interface, thereby revealing the suspect face underneath. As the raw video is displayed by the first layer, the overlaid timestamp layer does not interact with the raw video.

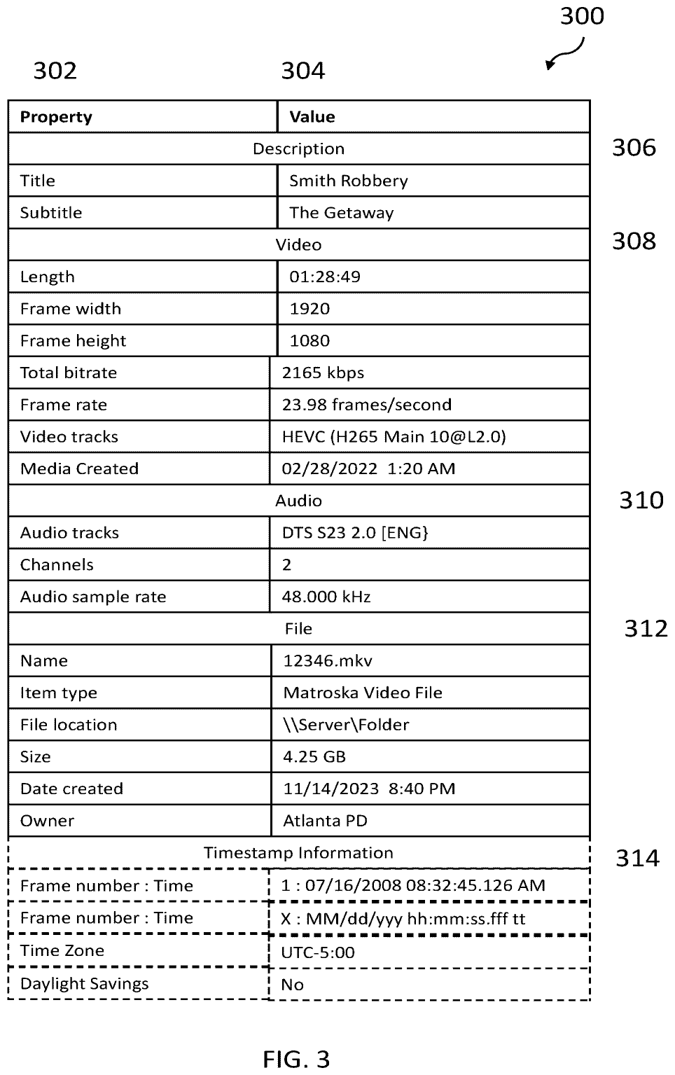

FIG. 3 is a diagram on exemplary video metadata according to an embodiment of the subject matter described herein. Metadata (or metainformation) may be data that provides information about other data but not the content of the data itself, such the frame(s) of a video itself. There may be one or more types of video metadata including descriptive, administrative, and structural. Descriptive metadata may include video contextual information such as title, tags, description, and technical information like runtime, file type, size, or date created. Administrative metadata may include information on who owns a file and who is permitted access. Administrative metadata may include user requirements, copyright information, rights management, license agreements, and other technical data. Structural metadata may describe the relationship between assets for organizing the video contents. This can include the episodes in a video series. The subject matter disclosed herein is primarily concerned with descriptive metadata for video files and, therefore, when the term “metadata” is used herein it may be understood to refer to at least descriptive type metadata.

In various embodiment, metadata, or the vocabulary used to assemble metadata statements, may be structured according to a metadata scheme. A metadata syntax may refer to one or more rules created to structure the fields and/or elements of metadata. A metadata scheme may be expressed in a number of different markup or programming languages, each of which may use a different syntax. Metadata schemata can be hierarchical where relationships exist between metadata elements and elements are nested so that parent-child relationships exist between the elements.

In FIG. 3, metadata scheme 300 may include a plurality of properties 302 and associated values 304 (metadata “tuples”). These tuples may be divided into several conventional categories: description metadata 306, video metadata 308, audio metadata 310, file metadata 312. A new metadata category including timestamp information 314, however, may be added and/or appended to the metadata scheme 300.

In various embodiments, descriptive metadata 306 may include, for example, the title and subtitle of the video as metadata properties. Here, the title (property) is associated with the “Smith Robbery” (value) and the subtitle (property) is associated with the “The Getaway” (value). Thus, when a video player plays the video and reads the associated with metadata 300, the video may be “Smith Robbery: The Getaway”. It is appreciated that this may be different from the file name of the video as will be discussed below.

In various embodiments, video metadata 308 may include, for example, the length, frame width, frame height, total bitrate, frame rate, video track information, and media creation date of the video as metadata properties. Here, the length (property) is associated with the “01:28:49” (value) in hh:mm:ss format indicating that the video is one hour, twenty-eight minutes, and forty-nine seconds long. The frame width and frame height indicate that the video has a resolution of 1920×1080 pixels. The frame rate indicates approximately 24 fps. The video tracks indicate the video is an HVEC file. The media creation date indicates that the video was created on Feb. 28, 2022 at 1:20 AM.

In various embodiments, audio metadata 310 may include, for example, the number and format of the audio tracks, the number of audio channels, and the audio sample rate of the video as metadata properties. Here, the properties indicate that the video has an English language DTS stereo track at 48 kHz.

In various embodiments, file metadata 312 may include, for example, the name, item type, file location, size, creation date, and owner of the video as metadata properties. Here, the properties indicate that the filename is 123456.mp4 and is a 4.25 GB Matroska format video file stored in a folder “Folder” on server “Server”. Additionally, the properties indicate that Atlanta PD is the owner of the file and was first stored at \\Server\Folder on Nov. 14, 2023 at 8:40 pm which is different from/later than the creation of the video by the video source/camera.

In various embodiments, timestamp information 314 may include new information not previously included in or associated with streamed or recorded video files. For example, the metadata properties may include the local time zone of the video at the time it was recorded and whether Daylight Savings or other time zone adjustments applied. In the example shown, the video was recorded on the East Coast of the US (UTC-5) during a time of the year when Daylight savings did not apply.

In various embodiments, time metadata 314 may include a plurality of frame numbers and corresponding timestamps. An individual timestamp may be associated with each frame of the video or the timestamp may be calculated for each frame. This may include interpolating based on determining timestamps for a portion of the frames and determining the time of an intermediate frame based on the frame rate or other factors.

It may also be appreciated that the example shown is primarily drawn to a particular format of recorded video file but that the subject matter described herein may also be applied to streaming or other compressed video formats. Compressed video may include a key frame and then a stream of changes relative to the key frame until these changes diverge too much. When this occurs, a new key frame may be generated. Thus, there may not be discreet frames in between the key frames like the example shown in FIG. 3. A video stream may instead include a plurality of streams running in parallel and synchronized with the frame rate. In other words, individual frames of a full-motion video may not necessarily be like photos as there may not be per-frame metadata.

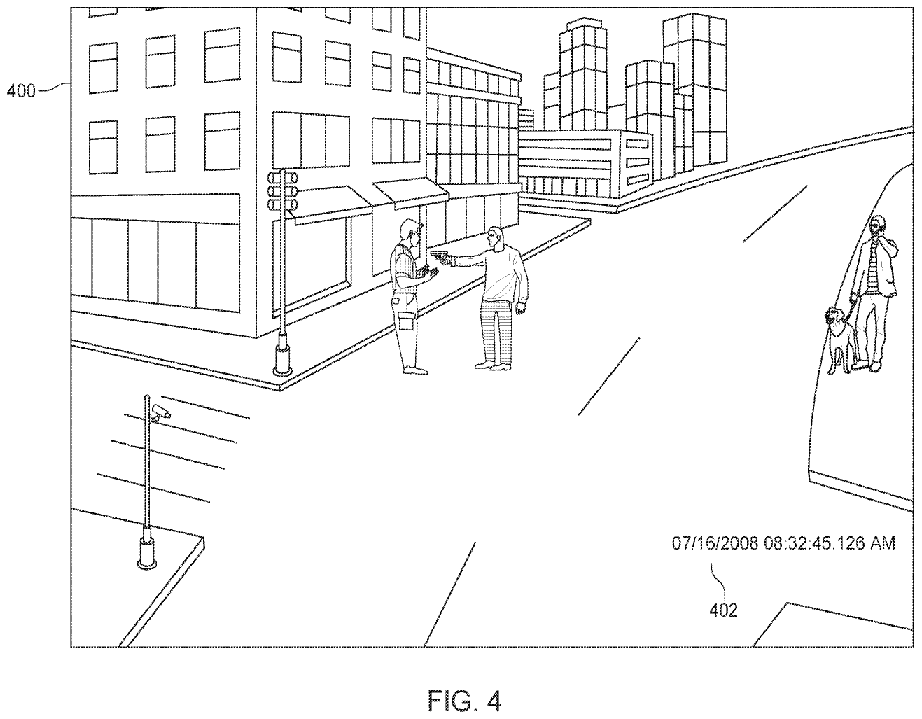

FIG. 4 illustrates an exemplary interface generated and presented during operations of the system of FIGS. 1A and 1B. Referring to FIG. 4, UI main view 400 shows a still image or frame of a time-stamped video file composed of a raw video file displayed as a first layer and a timestamp displayed on top as a second layer.

A main view 400 may be shown in an enlarged or zoomed-in format. Main view 400 may also comprise a live, current, real time, or near real time video feed. As shown in FIG. 4, main view 400 may be view of a street scene including building, light posts, and several people. It is appreciated that main view 400 is not limited to a live view. It is also appreciated that main view 400 may be selected from other views or may include a new or different view of video information.

The UI 400 may also include an overlay 402 for displaying the timestamp associated with the currently displayed frame. For example, info box 402 may indicate that the scene including building, light posts, and the people shown in view 400 was recorded at 8:32:45:126 AM on Jul. 16, 2008.

As mentioned above, the second presentation layer 402 is moveable, resizable, or otherwise manipulable by the user without affecting the first presentation layer 400. For example, the user may click to drag the overlaid timestamp layer 402 from one corner of the display to another corner.

In various embodiments, instead of, or in addition to, performing the functions described herein manually, the system may perform some or all the functions using machine learning or artificial intelligence. Generally, machine learning-enabled software may rely on unsupervised and/or supervised learning processes to perform the functions described herein in place of a human user. Additionally, machine learning (ML) may be the use of one or more computer algorithms that iteratively improve through experience and using data. Machine learning algorithms may build a model based on sample data, also known as training data, to make predictions or decisions without being explicitly programmed to do so. Machine learning algorithms are used where it is unfeasible to develop conventional algorithms to perform the needed tasks.

Machine learning may include identifying one or more data sources and extracting data from the identified data sources. Instead of or in addition to transforming the data into a rigid, structured format, in which metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In various embodiments, machine learning-based software assembles data into an organized format using one or more unsupervised learning techniques. Unsupervised learning techniques can identify relationships between data elements in an unstructured format.

In various embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

We claim:

1. A method for creating a video file including verified time information using appended video metadata, the method comprising:
at a video source or a device associated with a video source:
recording or streaming a raw video file;
communicating with a remote time source to determine time information for a plurality of portions of the video;
generating a time-stamped video file by appending metadata associated with the raw video file with the time information.

2. The method of claim 1, wherein the raw video file contains unmodified video information.

3. The method of claim 1, wherein appending the metadata includes adding one or more fields.

4. The method of claim 1, wherein the remote time source is a public network time protocol (NTP) server.

5. The method of claim 1, wherein the time information includes a timestamp associated with each frame of the video.

6. The method of claim 1, wherein the time information includes a timestamp calculated by interpolating between one or more reference frames.

7. The method of claim 1, wherein the time information includes an estimate of a local time associated with the video file being recorded or streamed, the estimate being associated with Coordinated Universal Time and verified by the remote time server to within a predetermined interval.

8. The method of claim 1, further comprising at least one of: saving the time-stamped video file locally, uploading time-stamped video file to a cloud platform, or streaming the time-stamped video file to a remote device.

9. The method of claim 1, further comprising encrypting the time-stamped video file and the metadata immediately upon recording or creation, the metadata including the time information.

10. The method of claim 1, wherein the time-stamped video file is encrypted when transmitted from the video source to a cloud platform.

11. The method of claim 1, wherein the video file is encrypted when stored by a cloud platform.

12. A method for displaying a video file including verified time information using appended video metadata, the method comprising:
receiving a time-stamped video file that includes raw video information and metadata appended with time information;
displaying the raw video information as a first presentation layer; and
displaying the timestamp information as a second presentation layer,
wherein the second presentation layer is independent from the first presentation layer, and
wherein the second presentation layer is overlaid onto the first presentation layer such that at least a first portion of the first presentation layer is obscured by at least a second portion of the second presentation layer.

13. The method of claim 12, wherein the time-stamped video file is encrypted when received and is decrypted while being displayed.

14. The method of claim 12, wherein the second presentation layer is moveable relative to the fire presentation layer.

15. The method of claim 12, wherein the first portion of the first presentation layer may be revealed by moving the second portion of the second presentation layer to overlay the second portion of the second presentation layer onto a third portion of the first presentation layer.

16. A method for creating a video file, the method comprising:
receiving, from a video source, a raw video file comprising original video information;
determining, based at least on a remote time source, time information associated with the raw video file;
determining, based at least on the time information, a plurality of timestamps associated with a plurality of frames that comprise the raw video file;
generating a time-stamped video file by appending metadata associated with the raw video file with the plurality of timestamps.

17. The method of claim 16, wherein the remote time source provides the time information, the time information provided by the remote time source being verified time information.

18. The method of claim 17, wherein the verified time information is associated with an error interval less than a predetermined interval.

19. The method of claim 16, wherein the time-stamped video file comprises at least the raw video file and the metadata.

20. The method of claim 19, wherein appending the metadata with the plurality of timestamps comprises adding one or more fields to the metadata that associated individual timestamps of the plurality of timestamps with individual frames of the plurality of frames.
